(19) United States
(12) Patent Application Publication
(10) Pub. No.: US 2025/0143513 A1
(43) Pub. Date: May 8, 2025

(54) FRY COOKING METHOD, METHOD FOR SUPPRESSING DETERIORATION OF SILICONE OIL-CONTAINING OIL AND FAT, AND FRY COOKING DEVICE

(71) Applicant: The Nisshin OilliO Group, Ltd., Tokyo (JP)

(72) Inventors: Takahide Watanabe, Yokohama-shi (JP); Kanji Aoyagi, Yokohama-shi (JP)

(73) Assignee: The Nisshin OilliO Group, Ltd., Tokyo (JP)

(21) Appl. No.: 18/898,583

(22) Filed: Sep. 26, 2024

Related U.S. Application Data
(63) Continuation of application No. 15/733,220, filed on Jun. 11, 2020, now abandoned.

(30) Foreign Application Priority Data
Dec. 12, 2017 (JP) 2017-237391
Feb. 15, 2018 (JP) 2018-025002
Feb. 20, 2018 (JP) 2018-027583

(51) Int. Cl. A47J 37/12

(52) U.S. Cl. CPC A47J 37/1271; A23D 9/007; A23L 5/11

(57) ABSTRACT

In order to suppress the deterioration of frying oil and fat, there are provided: a fry cooking method that uses a silicone-oil containing oil and fat as the frying oil and fat and forcibly cools the surface of the frying oil and fat; a method for suppressing the deterioration of a silicone oil-containing oil and fat, the method including forcibly cooling the surface of the silicone oil-containing oil and fat during the heating of the silicone oil-containing oil and fat; and a fry cooking device provided with a fryer into which the silicone oil-containing oil and fat is placed as the frying oil and fat, and a forced cooling device (blower) for forcibly cooling the oil surface of the silicone oil-containing oil and fat placed in the fryer.

### TECHNICAL FIELD

The present invention relates to a fry cooking method, a method for suppressing deterioration of a silicone oil-containing oil-and/or-fat, and a fry cooking device.

### BACKGROUND ART

In recent years, there has been an increasing interest in quality of food, and edible oils-and/or-fats used for processed food such as deep-fried food are no exception. In general, edible oils-and/or-fats degrade in response to heat and light. At this time, hydrolytic degradation due to the presence of water and oxidative degradation due to the presence of oxygen occur, causing deterioration of taste and color. Particularly in case of fry cooking to cook fried foods, tempuras or deep fried foods (“karaages”), etc., it is important to reduce deterioration since food is cooked in oil at around 180° C. For example, “Standards and criteria for food and food additives, etc. (Japanese Ministry of Health and Welfare, Notification No. 370, 1959)” state that oils-and/or-fats contained in instant noodles should not have an acid value of more than 3 or a peroxide value of more than 30. Deterioration of frying oils-and/or-fats also causes discoloration thereof, or an increase in the amount of polymers or polar substances therein. When the frying oils-and/or-fats are discolored, fried food is also discolored accordingly and thus has a poor appearance. The increase in the amount of polymers or polar substances in the frying oils-and/or-fats affects bubbling during frying. Thus, the acid value, discoloration and the amount of polymers, etc., of the frying oils-and/or-fats provide a benchmark for time to replace the frying oils-and/or-fats.

Commercial-use frying oils-and/or-fats used in supermarkets, eating and drinking places, restaurants, etc., are often used for frying a large amount of food at high temperature for a long time and thus degrade more rapidly than frying oils-and/or-fats used at home. For this reason, it is necessary to dispose or replace within a short period of time but this is a heavy burden in terms of finance as well as environment, hence, there has been need of a technique to suppress deterioration of frying oils-and/or-fats.

Based on such a fact, Patent Literature 1 proposes a method for suppressing oxidation of frying oil-and/or-fat, wherein a floating lid is placed to float on the frying oil-and/or-fat to suppress contact between the frying oil-and/or-fat and the air. Patent Literature 2 proposes a far-infrared heating vacuum fryer also as a method to suppress contact between the frying oil-and/or-fat and the air. Furthermore, Patent Literature 3 proposes a method for suppressing oxidation of frying oil-and/or-fat, wherein alkaline ionized water at pH of not less than 10 is sprayed onto the surface of frying oil. Patent Literature 4 proposes a method in which quality deterioration of pre-fried food materials due to thermal degradation and oxidation of oil is suppressed by suppressing temperature drop of the oil surface and applying a jet of superheated steam in a low-oxygen superheated steam atmosphere in a low-pressure high-temperature superheated steam device.

### CITATION LIST

### Patent Literatures

Patent Literature 1: JP 2008-6213A
Patent Literature 2: JP S62-277921A
Patent Literature 3: JP 2010-193737A
Patent Literature 4: JP H8-252177A

### SUMMARY OF INVENTION

### Technical Problem

However, the method in Patent Literature 1 requires to remove the floating lid during the frying operation and thus has a problem that the effect is not expected when frying is carried out constantly. The method in Patent Literature 2 also requires to remove the lid and it is thus not possible to continuously fry, and in addition, it is also necessary to increase the size of the device to fry a large amount of food. In addition, the method in Patent Literature 3 requires protection of eyes to suppress vision loss since not less than pH 10 is strong alkali, and there is also a work safety problem such as a risk of bumping which occurs when a large water drop falls in the oil. The method in Patent Literature 4 is characterized in the process after frying and cannot suppress deterioration of the frying oil-and/or-fat.

Therefore, there has been a demand for a fry cooking method and a fry cooking device which allow continuous frying, are highly safe, and can suppress deterioration of frying oils-and/or-fats in fry cooking.

Therefore, it is an object of the invention to provide a fry cooking method to suppress deterioration of frying oils-and/or-fats, a method for suppressing deterioration of a silicone oil-containing oil-and/or-fat, and a fry cooking device.

### Solution to Problem

The fry cooking method of the invention is characterized in that a silicone oil-containing oil-and/or-fat is used as a frying oil-and/or-fat, and the surface of the frying oil-and/or-fat is forcibly cooled.

It is preferable that the forcibly cooling be carried out during frying and/or during heating of the frying oil-and/or-fat before and/or after frying.

It is preferable that the forcibly cooling be achieved by replacing a gas in contact with a surface of the frying oil-and/or-fat, and a gas replaced with the gas in contact with the surface of the frying oil-and/or-fat comprise one type of gas selected from air, nitrogen, carbon dioxide gas and water vapor, or a mixture gas of one or more thereof.

It is preferable that the forcibly cooling be achieved by evaporation of fine water particles in the gas caused by contact with the frying oil-and/or-fat.

It is preferable that the forcibly cooling comprise forced air cooling.

It is preferable that the silicone oil-containing oil-and/or-fat comprise not less than 0.1 ppm of silicone oil.

It is preferable that a temperature of the frying oil-and/or-fat be not less than 120° C.

It is preferable that the forcibly cooling be carried out so that a wind speed at the surface of the frying oil-and/or-fat is not less than 0.3 m/s.

The method for suppressing deterioration of a silicone oil-containing oil-and/or-fat of the invention is characterized in that the surface of the silicone oil-containing oil-and/or-fat is forcibly cooled during heating of the silicone oil-containing oil-and/or-fat.

It is preferable that the forcibly cooling be achieved by replacing a gas in contact with a surface of the frying oil-and/or-fat, and a gas replaced with the gas in contact with the surface of the frying oil-and/or-fat comprise one type of gas selected from air, nitrogen, carbon dioxide gas and water vapor, or a mixture gas of one or more thereof.

It is preferable that the silicone oil-containing oil-and/or-fat comprise not less than 0.1 ppm of silicone oil.

It is preferable that a temperature of the silicone oil-containing oil-and/or-fat be not less than 120° C.

It is preferable that the forcibly cooling be carried out so that a wind speed at the surface of the silicone oil-containing oil-and/or-fat is not less than 0.3 m/s.

The fry cooking device of the invention is characterized in having a fryer in which a frying oil-and/or-fat is placed, and a forced cooling device for forcibly cooling the surface of the frying oil-and/or-fat placed in the fryer.

It is preferable that the forced cooling device comprise a blower to replace a gas in contact with a surface of the frying oil-and/or-fat, and a gas blown from the blower comprise one type of gas selected from air, nitrogen, carbon dioxide gas and water vapor, or a mixture gas of one or more thereof.

It is preferable that the gas blown from the blower comprise air at not more than 100° C.

It is preferable that the frying oil-and/or-fat comprise a silicone oil-containing oil-and/or-fat.

It is preferable that the silicone oil-containing oil-and/or-fat comprise not less than 0.1 ppm of silicone oil.

It is preferable that the forced cooling device operate so that a wind speed at the surface of the frying oil-and/or-fat is not less than 0.3 m/s.

It is preferable that the forced cooling device further comprise a mist generator.

### Advantageous Effects of Invention

According to the invention, it is possible to provide a fry cooking method and a fry cooking device which suppress deterioration of frying oils-and/or-fats. By using such fry cooking method and fry cooking device, it is possible to suppress deterioration of frying oils-and/or-fats containing a silicone oil. Furthermore, it is possible to provide a method for suppressing deterioration during heating of a silicone oil-containing oil-and/or-fat. In addition, according to the invention, fry cooking can be carried out continuously or anytime since sealing the frying oil-and/or-fat to suppress deterioration is not necessary at the time of heating the silicone oil-containing oil-and/or-fat unlike the Patent Literatures 1 and 2, and it is also possible to provide a fry cooking method, a method for suppressing deterioration of a silicone oil-containing oil-and/or-fat, and a fry cooking device which are highly safe.

### BRIEF DESCRIPTION OF DRAWINGS

FIG. 1A is a schematic diagram illustrating a specific example of the fry cooking device of the invention.

FIG. 1B is a schematic diagram illustrating a specific example of the fry cooking device of the invention.

FIG. 2 is a graph showing a relation between the wind speed and the acid value when wind is blown during heating of oils-and/or-fats not containing a silicone oil and silicone oil-containing oils-and/or-fats.

FIG. 3 is a graph showing a relation between the wind speed and polymers when wind is blown during heating of oils-and/or-fats not containing a silicone oil and silicone oil-containing oils-and/or-fats.

### DESCRIPTION OF EMBODIMENT

The present inventors found that deterioration of oils-and/or-fats is suppressed by forcibly cooling the surface of heated silicone oil-containing oil-and/or-fat. Based on this finding, a fry cooking method, a method for suppressing deterioration of a silicone oil-containing oil-and/or-fat, and a fry cooking device of the invention of the present application were completed. In the embodiment of the invention, A (numerical value) to B (numerical value) means not less than A and not more than B.

### <Fry Cooking Method>

In the fry cooking method of the invention, a silicone oil-containing oil-and/or-fat is used as a frying oil-and/or-fat and the surface of the frying oil-and/or-fat is forcibly cooled. Next, the fry cooking method will be described in detail.

### Frying Oil-and/or-Fat

The frying oil-and/or-fat used in the invention is a silicone oil-containing oil-and/or-fat. The silicone oil-containing oil-and/or-fat is a commonly used edible oil containing a silicone oil.

In the invention, when the silicone oil-containing oil-and/or-fat is used as the frying oil-and/or-fat of which surface is forcibly cooled, it is possible to suppress deterioration of the frying oil-and/or-fat. It is considered that this is because oxidative degradation and thermal degradation are suppressed because of the temperature drop of the surface of the frying oil-and/or-fat.

Even when the surface of a frying oil-and/or-fat not containing a silicone oil is forcibly cooled, the surface temperature of the frying oil-and/or-fat does not drop very much, and if air is used for cooling, deterioration rather accelerates.

The reason for such a difference in effect is considered to be as follows: in case of the frying oil-and/or-fat not containing a silicone oil, convection occurs in the frying oil-and/or-fat and prevents the surface temperature of the frying oil-and/or-fat from dropping, and in addition to this, oxygen in the air is supplied to the surface of the frying oil-and/or-fat, hence, deterioration accelerates. On the other hand, in case of the silicone oil-containing oil-and/or-fat, the silicone oil forms a thin film on the surface of the oil-and/or-fat and this layer prevents convection from occurring in the frying oil-and/or-fat. The surface temperature of the frying oil-and/or-fat drops since the convection does not occur, resulting in that the deterioration reaction rate decreases even if oxygen in the air is supplied to the surface of the frying oil-and/or-fat.

The purpose of adding a silicon oil to a common frying oil-and/or-fat is to form a silicon oil layer on the surface of the frying oil-and/or-fat and thereby to suppress the formation of foam during frying and to suppress oxidation. Therefore, the silicone oil content in the silicone oil-containing oil-and/or-fat of the invention is expected to be enough to obtain the effect to the extent that the silicone oil-containing oil-and/or-fat is used as a common frying oil-and/or-fat. The silicone oil content (mass fraction) in the silicone oil-containing oil-and/or-fat is preferably, e.g., not less than 0.1 ppm. The silicone oil content (mass fraction) in the silicone oil-containing oil-and/or-fat is more preferably 0.5 to 10 ppm, further preferably 0.5 to 5 ppm, and most preferably 1 to 4 ppm.

The silicone oil contained in the silicone oil-containing oil-and/or-fat here can be a commercially-available food grade silicone oil, and examples thereof include, but not limited to, a silicone oil which has a dimethylpolysiloxane structure and a kinematic viscosity of 800 to 5,000 mm²/s at 25° C. The kinematic viscosity of the silicone oil is particularly preferably 800 to 2,000 mm²/s, further preferably 900 to 1,100 mm²/s. The “kinematic viscosity” as used herein refers to a value as measured in accordance with JIS K 2283 (2000). The silicone oil may contain silica microparticles in addition to the silicone oil.

As the oil-and/or-fat contained in the silicone oil-containing oil-and/or-fat, animal and vegetable oils or processed oils can be used alone or as a mixture thereof. The animal and vegetable oils include palm oil, soybean oil, rapeseed oil, rice oil, sunflower oil, corn oil, safflower oil, cottonseed oil, sesame seed oil, grape seed oil, peanut oil, olive oil, coconut oil, and fractionated oils thereof. The processed oils include hydrogenated oils-and/or-fats, transesterified oils-and/or-fats, and esterified oils-and/or-fats, etc. Oils-and/or-fats having a high proportion of saturated fatty acids or monovalent unsaturated fatty acids in glyceride constituent fatty acids are preferable since oxidative stability is excellent. High-oleic rapeseed oil, high-oleic sunflower oil, high-oleic safflower oil, olive oil and high-oleic soybean oil, etc., are preferable since a percentage of oleic acids in the glyceride constituent fatty acids is high. Meanwhile, oils-and/or-fats which are solid at room temperature need to be melted by heating when used, hence, oils-and/or-fats in the liquid form at 20° C. are preferable.

### Fry Cooking

In the fry cooking of the invention, the forced cooling described below is carried out. In this regard, the forced cooling is preferably carried out not only during when actually frying food but also during heating before and/or after frying since the frying oil-and/or-fat deteriorates during heating. However, the forced cooling can be carried out only during frying food or only during heating before and/or after frying. It is applicable to any fry cooking, regardless of deep frying or shallow frying.

### Forced Cooling

In the fry cooking method of the invention, the surface of the frying oil-and/or-fat is forcibly cooled. The “forced cooling” in the invention means that natural cooling without any process is excluded and cooling involves a process of some kind. In the fry cooking, since the frying oil-and/or-fat is in contact with the air at high temperature, a gas in contact with the surface is replaced, or evaporation of fine water particles (mist) in the gas is caused by contact with the frying oil-and/or-fat, to lower the surface temperature of the frying oil-and/or-fat. Therefore, the higher the temperature of the frying oil-and/or-fat, the higher the effect of the invention. The temperature of the frying oil-and/or-fat is preferably not less than 120° C., more preferably 150 to 220° C., further preferably 160 to 200° C. In the invention, the frying oil-and/or-fat has such temperatures in the internal portion but the surface temperature is lower than the internal temperature since the surface of the frying oil-and/or-fat is forcibly cooled.

In the invention, when forcibly cooling the surface of the frying oil-and/or-fat, it is possible to forcibly cool by replacing a gas in contact with the surface of the frying oil-and/or-fat. The means for replacing the gas in contact with the surface of the frying oil-and/or-fat is not specifically limited, and it is possible to use a means for blowing a gas onto the surface of the frying oil-and/or-fat and/or a means for evacuating the gas at the surface of the frying oil-and/or-fat.

As an example of the means for blowing a gas onto the surface of the frying oil-and/or-fat, it is possible to blow a gas toward the surface of the frying oil-and/or-fat by using a fan. It is also possible to blow a gas by an air blow duct equipped with a fan, or a compressed air jet nozzle, etc., which is directed toward the surface of the frying oil-and/or-fat. As a simple way of obtaining the effect of the invention of the present application, it is possible to use an electric fan and blow the air toward the surface of the frying oil-and/or-fat. The angle of blowing the gas onto the surface of the frying oil-and/or-fat is not specifically limited. Since the invention can be implemented by replacing the gas at the surface of the frying oil-and/or-fat, the air may be blown, e.g., parallel to the surface of the frying oil-and/or-fat or 90° (perpendicular) to the surface of the frying oil-and/or-fat, but the angle of the air blown onto the surface of the frying oil-and/or-fat (hereinafter, referred to as the “incident angle (θ)) is preferably 10 to 90° in view of efficiency, the incident angle (θ) of 10 to 80° is more preferable, and the incident angle (θ) of 20 to 60° is further preferable.

Examples of the means for evacuating the gas at the surface of the frying oil-and/or-fat include placing an exhaust air duct with a fan in the vicinity of the surface of the frying oil-and/or-fat. Usually, an exhaust ventilation equipment such as extractor fan is provided above the frying device, but it cannot be expected that this has the effect of the invention of the present application since its purpose is to remove odor in indoor spaces caused by fry cooking and also it is located quite above the frying device and is thus hardly able to eliminate the gas at the surface of the frying oil-and/or-fat.

In the invention, a gas which can be used as a replacement for the gas in contact with the surface of the frying oil-and/or-fat is one type of gas selected from air, nitrogen, carbon dioxide gas and water vapor, or a mixture gas of one or more thereof. In the invention, normal air is sufficiently effective to suppress deterioration as described above, but nitrogen, carbon dioxide gas and water vapor are preferable since oxygen at the surface of the frying oil-and/or-fat can be reduced. However, oxygen deficiency may occur when using nitrogen or carbon dioxide gas. Therefore, it is preferable to ventilate sufficiently or to use a mixture gas containing the air.

In the invention, the “forced cooling” in which the surface of the frying oil-and/or-fat is cooled by blowing the air is the most preferable.

In the invention, the surface temperature of the frying oil-and/or-fat can be lowered using the heat of vaporization of water caused by contact between fine water particles (mist) in the gas and the frying oil-and/or-fat. The mist needs to suspend in the gas and is preferably smaller, e.g., preferably fine particles with a diameter of not more than 10 μm. It is also possible to combine with the above-described means for replacing the gas in contact with the surface. It is preferably provided, e.g., before and/or after the means for blowing the gas. The mist generator can be a commonly used device, and may be, e.g., a device which generates mist by injecting pressurized water through a mist nozzle with a very narrow diameter, or a device using ultrasonic wave.

In the invention, by using the silicone oil-containing oil-and/or-fat as the frying oil-and/or-fat and forcibly cooling the surface of the frying oil-and/or-fat, the temperature of the entire surface of the frying oil-and/or-fat or a portion of the surface of the frying oil-and/or-fat is lowered. The lowest temperature on the surface of the frying oil-and/or-fat obtained by forcibly cooling the surface of the frying oil-and/or-fat is preferably not less than 10° C. lower than the temperature of the internal portion of the frying oil-and/or-fat. The lowest temperature on the surface of the frying oil-and/or-fat obtained by forcibly cooling the surface of the frying oil-and/or-fat is more preferably not less than 15° C. lower, further preferably not less than 20° C. lower, most preferably not less than 25° C. lower than the temperature of the internal portion of the frying oil-and/or-fat.

In addition, the lowest temperature on the surface of the frying oil-and/or-fat obtained by using the silicone oil-containing oil-and/or-fat as the frying oil-and/or-fat and forcibly cooling the surface of the frying oil-and/or-fat is preferably not less than 5° C. lower than the surface temperature when not forcibly cooling the surface of the frying oil-and/or-fat. The lowest temperature on the surface of the frying oil-and/or-fat obtained by forcibly cooling the surface of the frying oil-and/or-fat is more preferably not less than 6° C. lower, further preferably not less than 10° C. lower, most preferably not less than 12° C. lower than the surface temperature when not forcibly cooling the surface of the frying oil-and/or-fat.

In the invention, the temperature of the center portion of the surface of the frying oil-and/or-fat obtained by using the silicone oil-containing oil-and/or-fat as the frying oil-and/or-fat and forcibly cooling the surface of the frying oil-and/or-fat is preferably not less than 2° C. lower than when not forcibly cooling the surface of the frying oil-and/or-fat. The temperature of the center portion of the surface of the frying oil-and/or-fat obtained by forcibly cooling the surface of the frying oil-and/or-fat is more preferably not less than 3° C. lower, further preferably not less than 5° C. lower than when not forcibly cooling the surface of the frying oil-and/or-fat. The center portion of the surface of the oil-and/or-fat here means the vicinity of the center between two farthest points which are located on the rim surrounding the surface of the frying oil-and/or-fat (the inner wall of the fryer) (e.g., an area about the center and within a distance which is ¼ of the distance from the center to the rim in all directions).

A preferable method for forcibly cooling the surface of the frying oil-and/or-fat is replacement of the gas in contact with the surface of the frying oil-and/or-fat by blowing a gas onto the surface of the frying oil-and/or-fat so as to have a wind speed of not less than 0.3 m/s at the surface of the frying oil-and/or-fat, and/or, by evacuating the gas at the surface of the frying oil-and/or-fat. The higher wind speed at the surface of the frying oil-and/or-fat is more promising to lower the surface temperature of the frying oil-and/or-fat, but too strong wind causes waves on the surface of the frying oil-and/or-fat and workability becomes poor. Therefore, the wind speed at the surface of the frying oil-and/or-fat is more preferably 0.5 to 5.0 m/s, further preferably 1.0 to 4.0 m/s, most preferably 1.5 to 2.5 m/s.

In the invention, replacement of the gas in contact with the surface of the frying oil-and/or-fat is performed to lower the temperature of the surface of the frying oil-and/or-fat. Therefore, the replacement gas needs to have a lower temperature than the frying oil-and/or-fat. Considering that fry cooking is carried out at about 120 to 200° C. (preferably about 150 to 200° C.), the temperature of the replacement gas is preferably not more than 100° C., more preferably not more than 60° C., further preferably not more than 40° C., most preferably room temperature (e.g., 5 to 30° C.).

### <Method for Suppressing Deterioration of Silicone Oil-Containing Oil-and/or-Fat>

In the method for suppressing deterioration of a silicone oil-containing oil-and/or-fat of the invention, the surface of the silicone oil-containing oil-and/or-fat is forcibly cooled during heating of the silicone oil-containing oil-and/or-fat.

### Silicone Oil-Containing Oil-and/or-Fat

The silicone oil-containing oil-and/or-fat used in the invention is a commonly used oil-and/or-fat containing a silicone oil. The silicone oil content in the silicone oil-containing oil-and/or-fat used in the invention is expected to be enough to obtain the effect to the extent that when the silicone oil-containing oil-and/or-fat is used as a common silicone oil-containing oil-and/or-fat. The silicone oil content (mass fraction) in the silicone oil-containing oil-and/or-fat is preferably, e.g., not less than 0.1 ppm. The silicone oil content (mass fraction) in the silicone oil-containing oil-and/or-fat is more preferably 0.5 to 10 ppm, further preferably 0.5 to 5 ppm, and most preferably 1 to 4 ppm.

The silicone oil contained in the silicone oil-containing oil-and/or-fat here can be a commercially-available food grade silicone oil, and examples thereof include, but not limited to, a silicone oil which has a dimethylpolysiloxane structure and a kinematic viscosity of 800 to 5,000 mm²/s at 25° C. The kinematic viscosity of the silicone oil is particularly preferably 800 to 2,000 mm²/s, further preferably 900 to 1,100 mm²/s. The “kinematic viscosity” as used herein refers to a value as measured in accordance with JIS K 2283 (2000). The silicone oil may contain silica microparticles in addition to the silicone oil.

As the oil-and/or-fat contained in the silicone oil-containing oil-and/or-fat, animal and vegetable oils or processed oils can be used alone or as a mixture thereof. The animal and vegetable oils include palm oil, soybean oil, rapeseed oil, rice oil, sunflower oil, corn oil, safflower oil, cottonseed oil, sesame seed oil, grape seed oil, peanut oil, olive oil, coconut oil, and fractionated oils thereof. The processed oils include hydrogenated oils-and/or-fats, transesterified oils-and/or-fats, and esterified oils-and/or-fats, etc. Oils-and/or-fats having a high proportion of saturated fatty acids or monovalent unsaturated fatty acids in glyceride constituent fatty acids are preferable since oxidative stability is excellent. High-oleic rapeseed oil, high-oleic sunflower oil, high-oleic safflower oil, olive oil and high-oleic soybean oil, etc., are preferable since a percentage of oleic acids in the glyceride constituent fatty acids is high. Meanwhile, oils-and/or-fats which are solid at room temperature need to be melted by heating when used, hence, oils-and/or-fats in the liquid form at 20° C. are preferable.

### Forced Cooling

In the invention, the surface temperature of the silicone oil-containing oil-and/or-fat is lowered by forcibly cooling the surface during when the silicone oil-containing oil-and/or-fat is in contact with the air at high temperature. Therefore, the higher the temperature of the silicone oil-containing oil-and/or-fat, the higher the effect of the invention. The temperature of the silicone oil-containing oil-and/or-fat is preferably not less than 120° C., more preferably 150 to 220° C., further preferably 160 to 200° C. In the invention, the silicone oil-containing oil-and/or-fat has such temperatures in the internal portion but the surface temperature is lower than the internal temperature since the surface of the silicone oil-containing oil-and/or-fat is forcibly cooled.

In the invention, when forcibly cooling the surface of the silicone oil-containing oil-and/or-fat, it is possible to forcibly cool by replacing a gas in contact with the surface of the silicone oil-containing oil-and/or-fat, and/or, by evaporation of fine water particles (mist) in the gas caused by contact with the frying oil-and/or-fat (using the heat of vaporization of water). The means for replacing the gas in contact with the surface of the silicone oil-containing oil-and/or-fat is not specifically limited, and it is possible to use a means for blowing a gas onto the surface of the silicone oil-containing oil-and/or-fat and/or a means for evacuating the gas at the surface of the silicone oil-containing oil-and/or-fat.

As an example of the means for blowing a gas onto the surface of the silicone oil-containing oil-and/or-fat, it is possible to blow a gas toward the surface of the silicone oil-containing oil-and/or-fat by using a fan. It is also possible to blow a gas by an air blow duct equipped with a fan, or a compressed air jet nozzle, etc., which is directed toward the surface of the silicone oil-containing oil-and/or-fat. As a simple way of obtaining the effect of the invention of the present application, it is possible to use an electric fan and blow the air toward the surface of the silicone oil-containing oil-and/or-fat. The angle of blowing the gas onto the surface of the silicone oil-containing oil-and/or-fat is not specifically limited. Since the invention can be implemented by replacing the gas at the surface of the silicone oil-containing oil-and/or-fat, the air may be blown, e.g., parallel to the surface of the silicone oil-containing oil-and/or-fat or 90° (perpendicular) to the surface of the silicone oil-containing oil-and/or-fat, but the incident angle (θ) is preferably 10 to 90° in view of efficiency, the incident angle (θ) of 10 to 80° is more preferable, and the incident angle (θ) of 20 to 60° is further preferable.

Examples of the means for evacuating the gas at the surface of the silicone oil-containing oil-and/or-fat include placing an exhaust air duct with a fan in the vicinity of the surface of the silicone oil-containing oil-and/or-fat.

In the invention, a gas which can be used as a replacement for the gas in contact with the surface of the silicone oil-containing oil-and/or-fat is one type of gas selected from air, nitrogen, carbon dioxide gas and water vapor, or a mixture gas of one or more thereof. In the invention, normal air is sufficiently effective to suppress deterioration as described above, but nitrogen, carbon dioxide gas and water vapor are preferable since oxygen at the surface of the silicone oil-containing oil-and/or-fat can be reduced. However, oxygen deficiency may occur when using nitrogen or carbon dioxide gas. Therefore, it is preferable to ventilate sufficiently or to use a mixture gas containing the air.

In the invention, the “forced cooling” in which the surface of the silicone oil-containing oil-and/or-fat is cooled by blowing the air is the most preferable.

In the invention, the surface temperature of the silicone oil-containing oil-and/or-fat can be lowered using the heat of vaporization of water caused by contact between fine water particles (mist) in the gas and the silicone oil-containing oil-and/or-fat. The mist needs to suspend in the gas and is preferably smaller, e.g., preferably fine particles with a diameter of not more than 10 μm. It is also possible to combine with the above-described means for replacing the gas in contact with the surface of the silicone oil-containing oil-and/or-fat. It is preferably provided, e.g., before and/or after the means for blowing the gas. The mist generator can be a commonly used device, and may be, e.g., a device which generates mist by injecting pressurized water through a mist nozzle with a very small diameter, or a device using ultrasonic wave.

In the invention, the lowest temperature on the surface of the silicone oil-containing oil-and/or-fat obtained by forcibly cooling the surface of the silicone oil-containing oil-and/or-fat is preferably not less than 10° C. lower than the temperature of the internal portion of the silicone oil-containing oil-and/or-fat. The lowest temperature on the surface of the silicone oil-containing oil-and/or-fat obtained by forcibly cooling the surface of the silicone oil-containing oil-and/or-fat is more preferably not less than 15° C. lower, further preferably not less than 20° C. lower, most preferably not less than 25° C. lower than the temperature of the internal portion of the silicone oil-containing oil-and/or-fat.

In addition, the lowest temperature on the surface of the silicone oil-containing oil-and/or-fat obtained by forcibly cooling the surface of the silicone oil-containing oil-and/or-fat is preferably not less than 5° C. lower than the surface temperature when not forcibly cooling the surface of the silicone oil-containing oil-and/or-fat. The lowest temperature on the surface of the silicone oil-containing oil-and/or-fat obtained by forcibly cooling the surface of the silicone oil-containing oil-and/or-fat is more preferably not less than 6° C. lower, further preferably not less than 10° C. lower, most preferably not less than 12° C. lower than the surface temperature when not forcibly cooling the surface of the silicone oil-containing oil-and/or-fat.

In the invention, the temperature of the center portion of the surface of the silicone oil-containing oil-and/or-fat obtained by forcibly cooling the surface of the silicone oil-containing oil-and/or-fat is preferably not less than 2° C. lower than when not forcibly cooling the surface of the silicone oil-containing oil-and/or-fat. The temperature of the center portion of the surface of the silicone oil-containing oil-and/or-fat obtained by forcibly cooling the surface of the silicone oil-containing oil-and/or-fat is more preferably not less than 3° C. lower, further preferably not less than 5° C. lower than when not forcibly cooling the surface of the silicone oil-containing oil-and/or-fat. The center portion of the surface of the silicone oil-containing oil-and/or-fat here means the vicinity of the center between two farthest points which are located on the rim surrounding the surface of the frying oil-and/or-fat (the inner wall of the fryer) (e.g., an area about the center and within a distance which is ¼ of the distance from the center to the rim in all directions).

A preferable method for forcibly cooling the surface of the silicone oil-containing oil-and/or-fat is replacement of the gas in contact with the surface of the silicone oil-containing oil-and/or-fat by blowing a gas onto the surface of the silicone oil-containing oil-and/or-fat so as to have a wind speed of not less than 0.3 m/s at the surface of the silicone oil-containing oil-and/or-fat, and/or, by evacuating the gas at the surface of the silicone oil-containing oil-and/or-fat. The higher wind speed at the surface of the silicone oil-containing oil-and/or-fat is more promising to lower the surface temperature of the silicone oil-containing oil-and/or-fat, but too strong wind causes waves on the surface of the silicone oil-containing oil-and/or-fat and workability becomes poor. Therefore, the wind speed at the surface of the silicone oil-containing oil-and/or-fat is more preferably 0.5 to 5.0 m/s, further preferably 1.0 to 4.0 m/s, most preferably 1.5 to 2.5 m/s.

In the invention, replacement of the gas in contact with the surface of the silicone oil-containing oil-and/or-fat is performed to lower the temperature of the surface of the silicone oil-containing oil-and/or-fat. Therefore, the replacement gas needs to have a lower temperature than the silicone oil-containing oil-and/or-fat. When the silicone oil-containing oil-and/or-fat is about 120 to 200° C., the temperature of the replacement gas is preferably not more than 100° C., more preferably not more than 60° C., further preferably not more than 40° C., most preferably room temperature (e.g., 5 to 30° C.).

### <Fry Cooking Device>

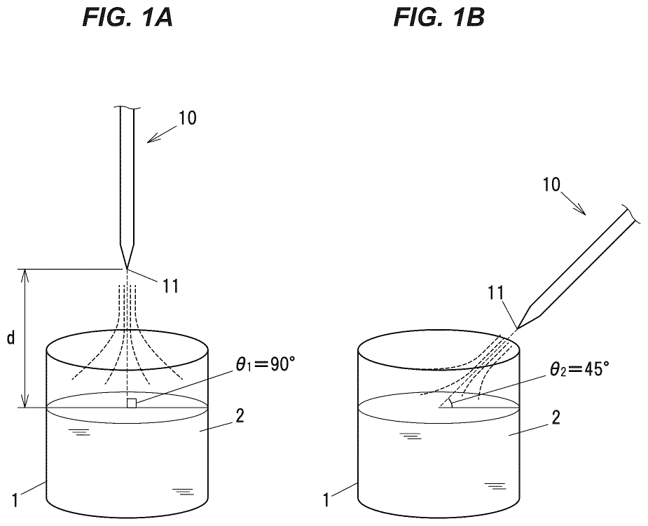

FIGS. 1A and 1B are schematic diagrams illustrating specific examples of the fry cooking device of the invention.

The fry cooking device of the invention is provided with a fryer 1 in which a silicone oil-containing oil-and/or-fat 2 as a frying oil-and/or-fat is placed, and a forced cooling device (a blower 10) for forcibly cooling the surface of the silicone oil-containing oil-and/or-fat 2 placed in the fryer 1.

The size and shape, etc., of the fryer 1 are not specifically limited. Both home fryer and commercial fryer can be used, but the commercial fryer is particularly suitable.

As the forced cooling device, it is possible to use a means for replacing a gas in contact with the surface of the frying oil-and/or-fat (described later), and it is possible to use, e.g., a means for blowing a gas onto the surface of the frying oil-and/or-fat (described later) and/or a means for evacuating a gas at the surface of the frying oil-and/or-fat (described later). The forced cooling device shown in FIGS. 1A and 1B is the blower 10 as the means for blowing a gas onto the surface of the frying oil-and/or-fat. The portion other than the tip including an air outlet 11 is not shown in the drawings. The blower 10 only needs to be able to blow the gas onto the surface of the frying oil-and/or-fat, and may be, e.g., an electric fan. The forced cooling performed by the forced cooling device will be described later. FIG. 1A shows an example in which an incident angle (θ₁) is 90°, and FIG. 1B shows an example in which an incident angle (θ₂) is 45°. The incident angle is an angle of the blowing direction with respect to the surface of the frying oil-and/or-fat when the gas is blown toward the surface of the frying oil-and/or-fat, as shown in FIGS. 1A and 1B (the same applies hereinafter).

A distance d between the air outlet 11 and the surface of the frying oil-and/or-fat is appropriately adjusted so that the forced cooling (described later) can be carried out.

The forced cooling device may be further provided with a mist generator so that fine water particles are added to the gas blown onto the surface of the frying oil-and/or-fat. In this case, the mist generator is preferably positioned on the front side and/or the rear side of the blower. In addition, the mist generator can be a commonly used device, and may be, e.g., a device which generates mist by injecting pressurized water through a mist nozzle with a very narrow diameter, or a device using ultrasonic wave.

### <Fry Cooking Conditions>

Fry cooking is carried out using the fry cooking device of the invention. The fry cooking device of the invention can be used in the above-described fry cooking method, but is not limited to a device used in only a specific fry cooking method and also includes those used in various fry cooking methods. For example, it is possible to carry out fry cooking without using the above-described the forced cooling device (carry out in the state that the device is not operating). However, in the fry cooking method for suppressing deterioration of the frying oil-and/or-fat, it is preferable to use the silicone oil-containing oil-and/or-fat as the frying oil-and/or-fat and to forcibly cool the surface of the frying oil-and/or-fat. Next, the conditions for such fry cooking will be described in detail.

### The Frying Oil-and/or-Fat

The frying oil-and/or-fat used in the fry cooking device of the invention is preferably a silicone oil-containing oil-and/or-fat. The silicone oil-containing oil-and/or-fat is a commonly used edible oil containing a silicone oil.

When the silicone oil-containing oil-and/or-fat is used as the frying oil-and/or-fat of which surface is forcibly cooled by the fry cooking device of the invention, it is possible to suppress deterioration of the frying oil-and/or-fat. It is considered that this is because oxidative degradation and thermal degradation are suppressed because of the temperature drop of the surface of the frying oil-and/or-fat.

Even when the surface of a frying oil-and/or-fat not containing a silicone oil is forcibly cooled, the surface temperature of the frying oil-and/or-fat does not drop very much, and if air is used for cooling, deterioration rather accelerates. Note that, the fry cooking device of the invention which can be used in a fry cooking method using a frying oil-and/or-fat not containing a silicone oil, etc., is also included in the scope of the fry cooking device of the invention as long as the silicone oil-containing oil-and/or-fat is used as the frying oil-and/or-fat and it is capable of forcibly cooling the surface of the frying oil-and/or-fat.

The reason for such a difference in effect is considered to be as follows: in case of the frying oil-and/or-fat not containing a silicone oil, convection occurs in the frying oil-and/or-fat and suppresses the surface temperature of the frying oil-and/or-fat from dropping, and in addition to this, oxygen in the air is supplied to the surface of the frying oil-and/or-fat, hence, deterioration accelerates. On the other hand, in case of the silicone oil-containing oil-and/or-fat, the silicone oil forms a thin film on the surface of the oil-and/or-fat and this layer prevents convection from occurring in the frying oil-and/or-fat. The surface temperature of the frying oil-and/or-fat drops since the convection does not occur, resulting in that the deterioration reaction rate decreases even if oxygen in the air is supplied to the surface of the frying oil-and/or-fat.

### Fry Cooking

In the fry cooking using the fry cooking device of the invention, the forced cooling described above is carried out. In this regard, the forced cooling is preferably carried out not only during when actually frying food but also during heating before and/or after frying since the frying oil-and/or-fat deteriorates during heating. However, the forced cooling can be carried out only during frying food or only during heating before and/or after frying. It is applicable to any fry cooking, regardless of deep frying or shallow frying.

### Forced Cooling

The fry cooking device of the invention forcibly cools the surface of the frying oil-and/or-fat. The details of the forced cooling, particularly the means of forced cooling and the function and effect of the forced cooling, are as described for the invention of the fry cooking method.

### EXAMPLES

Next, the invention will be specifically described based on Examples. However, the invention is not limited to these Examples.

### Heat Test

FIG. 1A shows the fry cooking device in Examples 1-1, 1-3 and Comparative Examples 1-1, 1-2, and FIG. 1B shows the fry cooking device in Example 1-2. (A beaker is used as the fryer 1, and a pipette connected to a pump via a tube is used as the blower 10).

### Reference Example 1, Comparative Examples 1-1, 1-2

50 g of refined rapeseed oil (manufactured by The Nisshin OilliO Group, Ltd.: not containing silicone oil) was put in each of three 200 ml beakers and each beaker was heated by a heater for 12 hours so that the oil temperature was maintained at 180° C. (Reference Example 1, Comparative Examples 1-1, 1-2). The oil temperature was checked by a stick thermometer (red liquid stick thermometer, manufactured by Tokyo Garasu Kikai, Co., Ltd). In Reference Example 1, heating was performed with no wind. In Comparative Examples 1-1 and 1-2, heating was performed while blowing air (room temperature) onto the oil surface. The air volume of wind on the oil surface and the incident angle of the air are shown in Table 1. The surface temperature at the center and lowest temperature of the oil surface, the acid value, the color value (Y+10R) and polymers, which were measured after heating for 12 hours, are shown in Table 1.

### Reference Example 2, Examples 1-1 to 1-3

50 g of refined rapeseed oil (manufactured by The Nisshin OilliO Group, Ltd.) containing 3 ppm (mass) of Silicone Oil KF-96 (manufactured by Shin-Etsu Chemical Co., Ltd.) was put in each of four 200 ml beakers and each beaker was heated by a heater for 24 hours so that the oil temperature was maintained at 180° C. (Reference Example 2, Examples 1-1 to 1-3). In Reference Example 2, heating was performed with no wind. In Examples 1-1 to 1-3, heating was performed while blowing air onto the oil surface. The air volume of wind on the oil surface and the incident angle of the air are shown in Table 2. The surface temperature at the center and lowest temperature of the oil surface, the acid value, the color value (Y+10R) and polymers, which were measured after heating for 24 hours, are shown in Table 2.

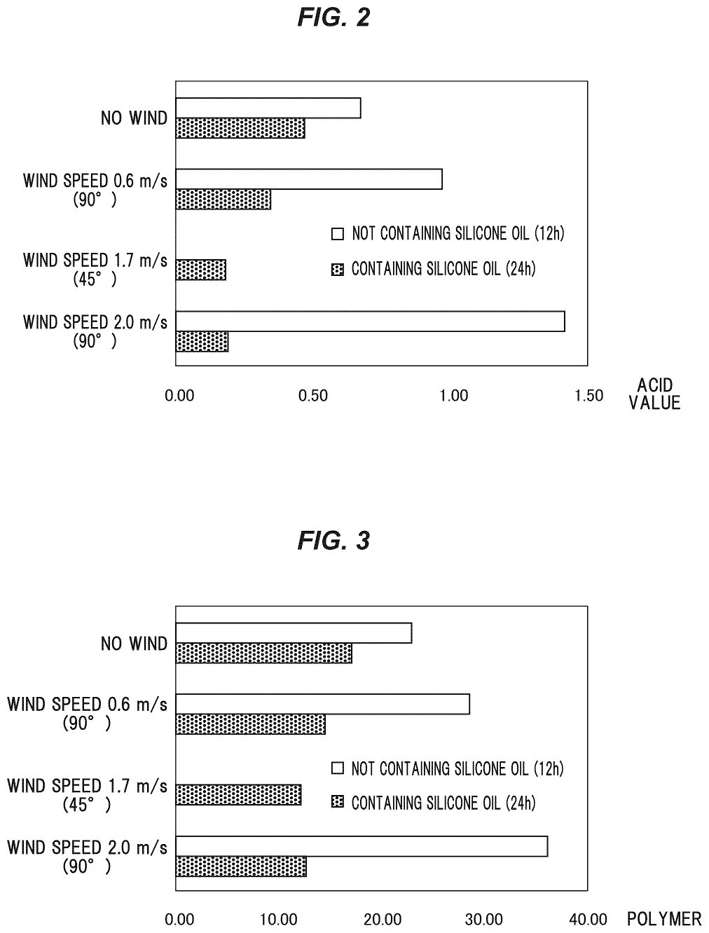

FIG. 2 is a graph showing a relation between the wind speed and the acid value shown in Tables 1 and 2. FIG. 3 is a graph showing a relation between the wind speed and the polymers shown in Tables 1 and 2.

### Analysis Method

### Surface Temperature of Frying Oil-and/or-Fat

The surface temperature of the frying oils-and/or-fats was measured using InfReC Thermography, model number R300 (manufactured by NEC Avio Infrared Technologies

Co., Ltd.). The surface temperature at the center is a temperature at the center of the surface of the frying oil-and/or-fat (at the center of the beaker), and the lowest surface temperature is a surface temperature which is the lowest point on the entire surface of the frying oil-and/or-fat.

### Wind Speed at Surface of Frying Oil-and/or-Fat

The wind speed at the surface of the frying oils-and/or-fats was measured using Digital Thermal Anemometer, testo 425 (from Testo SE & Co. KGaA).

### Acid Value

The acid value of the heated sample oils was measured in accordance with Standard Methods for the Analysis of Fats, Oils and Related Materials “2.3.1-2013 Acid value” (edited by Japan Oil Chemists' Society). The acid value indicates the amount of free fatty acids present in oil-and/or-fat, and is the number of mg of potassium hydroxide that is required to neutralize one gram of sample oil. The smaller acid value means that the increase in the acid value is more suppressed.

### Color Value (Y+10R)

The degree of discoloration of the heated sample oils was evaluated by measuring the degree of yellowness (Y) and the degree of redness (R) using a Lovibond colorimeter (Lovibond PFX995, manufactured by The Tintometer Limited) with a 1-inch cell, and then calculating the color value (Y+10R). The smaller color value means that the degree of discoloration by visual observation is smaller and discoloration is more suppressed.

### Polymers

The amount of polymers contained in the heated sample oils was measured in accordance with Standard Methods for the Analysis of Fats, Oils and Related Materials “2.5.7-2013 Polymerized Triacylglycerols (Gel-Permeation Chromatography)” (edited by Japan Oil Chemists' Society). The smaller numerical value means that the amount of produced polymers is more suppressed.

TABLE 1

| | | After heating for 12 hours (180° C.) | | | |
|---|---|---|---|---|---|
| | | Surface temperature | | Color | |
| | | at center (Lowest | Acid | value | |
| | | surface temperature) | value | Y + 10R | Polymers |
| Reference | No wind | 177.5° C. | 0.67 | 9.5 | 23.8 |
| Example 1 | | (176.4° C.) | | | |
| Comparative | Wind speed: 0.6 m/s | 176.9° C. | 0.97 | 11.6 | 29.7 |
| Example 1-1 | (d = 28 cm) | (173.0° C.) | | | |
| | (Incident angle 90°) | | | | |
| Comparative | Wind speed: 2.2 m/s | 176.8° C. | 1.42 | 20.0 | 37.7 |
| Example 1-2 | (d = 15 cm) | (175.4° C.) | | | |
| | (Incident angle 90°) | | | | |

TABLE 2

| | | After heating for 24 hours (180° C.) | | | |
|---|---|---|---|---|---|
| | | Surface temperature | | Color | |
| | | at center (Lowest | Acid | value | |
| | | surface temperature) | value | Y + 10R | Polymers |
| Reference | No wind | 169.1° C. | 0.47 | 9.7 | 17.7 |
| Example 2 | | (165.4° C.) | | | |
| Example 1-1 | Wind speed: 0.6 m/s | 166.2° C. | 0.35 | 9.7 | 15.2 |
| | (d = 28 cm) | (158.6° C.) | | | |
| | (Incident angle 90°) | | | | |
| Example 1-2 | Wind speed: 1.7 m/s | 163.0° C. | 0.18 | 8.8 | 12.6 |
| | (Incident angle 45°) | (155.2° C.) | | | |
| Example 1-3 | Wind speed: 2.2 m/s | 162.6° C. | 0.19 | 8.8 | 13.1 |
| | (d = 15 cm) | (152.7° C.) | | | |
| | (Incident angle 90°) | | | | |

In case of the oils-and/or-fats not containing silicone oil in Table 1, the forced cooling didn't lower the surface temperature even by 1° C. as compared to Reference Example 1. In addition, all the acid value, the color value and the polymers increased and it was confirmed that deterioration advanced in the oils-and/or-fats not containing silicone oil.

On the other hand, in case of the oils-and/or-fats containing silicone oil in Table 2, deterioration was suppressed even though it was heated for a longer time than the oils-and/or-fats not containing silicone oil. The forced cooling lowered the surface temperature by not less than 2° C. as compared to Reference Example 2, and all the acid value, the color value and the polymers were kept low. It was confirmed that deterioration of the oils-and/or-fats containing silicone oil was suppressed by the forced cooling.

### REFERENCE SIGNS LIST

1: fryer
2: silicone oil-containing oil-and/or-fat (frying oil-and/or-fat)
10: blower (forced cooling device)
11: air outlet

### INDUSTRIAL APPLICABILITY

It is possible to suppress deterioration of frying oils-and/or-fats containing silicone oil by using the fry cooking method and the fry cooking device of the invention. Furthermore, it is possible to provide a method for suppressing deterioration during heating of a silicone oil-containing oil-and/or-fat. In addition, according to the invention, fry cooking can be carried out continuously or anytime since sealing the frying oil-and/or-fat to suppress deterioration is not necessary at the time of heating the silicone oil-containing oil-and/or-fat, and it is also possible to provide a fry cooking method, a method for suppressing deterioration of a silicone oil-containing oil-and/or-fat, and a fry cooking device which are highly safe.

1. A cooking method for frying, comprising:
forcibly cooling a surface of frying oil and/or fat, the frying oil and/or fat comprising silicone oil, by blowing, to the silicone, a gas having a temperature between 5° C. and 100° C. and further comprising at least one selected from the group consisting of air, carbon dioxide gas, and combinations thereof,
wherein the silicone oil is an uppermost layer of the frying oil and/or fat.

2. The cooking method according to claim 1, wherein a lowest temperature on the surface of the frying oil and/or fat obtained by forcibly cooling the surface of the frying oil and/or fat is at least 5° C. lower than a surface temperature when not forcibly cooling the surface of the frying oil and/or fat.

3. The cooking method according to claim 1, wherein the frying oil and/or fat contains silicone oil as a film and form an upper surface of the frying oil and/or fat.

4. The fry cooking method according to claim 1, wherein the forcibly cooling is carried out during a time interval selected from the group consisting of:
during frying,
during heating of the frying oil and/or fat before frying,
during heating of the frying oil and/or fat after frying, and
during all of frying, heating of the frying oil and/or fat before frying, and heating of the frying oil and/or fat after frying.

5. The fry cooking method according to claim 1, wherein the gas comprises air.

6. The fry cooking method according to claim 1, wherein the frying oil and/or fat comprises not less than 0.1 ppm of silicone oil.

7. The fry cooking method according to claim 1, wherein a temperature of the frying oil and/or fat is not less than 120° C.

8. The fry cooking method according to claim 1, wherein the forcibly cooling is carried out so that a wind speed at the surface of the frying oil and/or fat is not less than 0.3 m/s.

9. The method according to claim 1, wherein the method is performed in a fry cooking device comprising:
a fryer in which the frying oil and/or fat is placed; and
a forced cooling device for forcibly cooling the surface of the frying oil and/or fat placed in the fryer.

10. The method according to claim 9, wherein the forced cooling device comprises a blower to blow the gas to the silicone oil thin film on the surface of the frying oil and/or fat, and the gas blown from the blower is selected from the group consisting of air, carbon dioxide gas, and combinations thereof.

11. The method according to claim 10, wherein the gas blown from the blower comprises air at not more than 100° C.

12. The method according to claim 1, wherein the frying oil and/or fat comprises not less than 0.1 ppm of silicone oil.

13. The method according to claim 9, wherein the forced cooling device operates so that a wind speed at the surface of the frying oil and/or fat is not less than 0.3 m/s.

14. The method according to claim 1, wherein the gas has a lower oxygen content relative to air.

15. The fry cooking method according to claim 1, wherein the gas is blown to the surface of the frying oil and/or fat at an incident angle of 20 to 60°.

16. The method according to claim 1, wherein a temperature of a center portion of the surface of frying oil and/or fat obtained by forcibly cooling the surface of the frying oil and/or fat is at least 2° C. lower than a surface temperature of the center portion when not forcibly cooling the surface of the frying oil and/or fat.

17. The fry cooking method according to claim 1, wherein the frying oil and/or fat comprises 1 to 4 ppm of silicone oil.

18. The fry cooking method according to claim 1, wherein the silicone oil has a dimethylpolysiloxane structure and a kinematic viscosity of 800 to 5,000 mm²/s at 25° C.

19. The fry cooking method according to claim 1, wherein the silicone oil has a dimethylpolysiloxane structure and a kinematic viscosity of 900 to 1,100 mm²/s at 25° C.
